(19) United States
(12) Patent Application Publication
(10) Pub. No.: US 2017/0138661 A1
(43) Pub. Date: May 18, 2017

(54) SELF-ADJUSTING CRYOGENIC FOOD FREEZER

(71) Applicants: Michael D. Newman, Hillsborough, NJ (US); Stephen McCormick, Warrington, PA (US)

(72) Inventors: Michael D. Newman, Hillsborough, NJ (US); Stephen McCormick, Warrington, PA (US)

(21) Appl. No.: 15/012,883

(22) Filed: Feb. 2, 2016

Related U.S. Application Data
(60) Provisional application No. 62/256,185, filed on Nov. 17, 2015.

(51) Int. Cl. F25D 29/00; A23L 3/375; A23L 3/36; F25D 3/11; A23L 3/00

(52) U.S. Cl. CPC F25D 29/001; F25D 3/11; F25D 29/005; A23L 3/001; A23L 3/361; A23L 3/375; F25D 2600/04; F25D 2700/16; A23V 2002/00

(57) ABSTRACT

A method for freezing a food product in a cryogenic freezer includes sensing at least one physical characteristic of the food product in real time, providing a cryogenic substance to the food product for heat transfer at said food product, automatically self-adjusting the heat transfer at the food product responsive to the sensing the at least one physical characteristic, and continuously self-adjusting the heat transfer for bringing the food product to a select temperature. A related freezer apparatus is also provided.

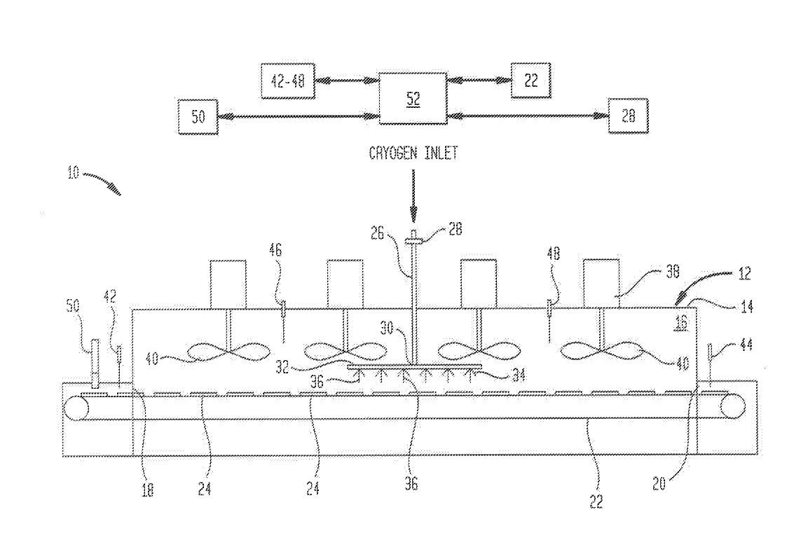

### BACKGROUND OF THE INVENTION

The present embodiments relate to cryogenic food freezing systems such as for example tunnel freezers, and those systems that automatically adjust an atmosphere, conveyor belt speed, blower speed, exhaust speed (extraction rates) and freezer temperatures of the freezer.

All known cryogenic food freezing systems require trained personnel to operate the systems to accordingly adjust the freezing conditions of same. Production rates within a food freezing system processing line are continually changing, i.e., inlet temperatures and hence heat load of products to be chilled/frozen by the system change, as do conditions in the processing facility which may impact the chilling/freezing of the food products. If the food freezing system is not controlled and adjusted to properly compensate for changing inlet and external conditions of the freezing system, the overall operating efficiency of the system will be impacted such that the system is used inefficiently, product such as food product is chilled or frozen inefficiently and ineffectively, and the cryogenic substance for chilling and/or freezing is unnecessarily wasted. In order to control and adjust such a system, it is typical for operators not to make immediate adjustments to compensate for food production line variability, because of the labor intensity to do so and the fact that very often such operators are not aware of the variable changes that occur along the processing line of the food freezer.

### SUMMARY OF THE INVENTION

There is therefore provided a method for freezing a food product in a cryogenic freezer which includes sensing at least one physical characteristic of the food product in real time; providing a cryogenic substance to the food product for heat transfer at said food product; automatically self-adjusting the heat transfer at the food product responsive to the sensing the at least one physical characteristic; and continuously self-adjusting the heat transfer for bringing the food product to a select temperature.

There is also provided a related cryogenic freezer for a food product which includes a housing having an internal chamber and a cryogen delivery member disposed therein; a conveyor for conveying the food product through the internal chamber; a laser scanner disposed at an inlet of the housing for scanning a cross-sectional area of the food product entering the cryogenic freezer; a pair of infrared (IR) temperature sensors, wherein a first IR sensor is disposed downstream of the laser scanner and upstream of an inlet to said internal chamber, and a second IR sensor is disposed downstream of an outlet of said internal chamber; and a controller interconnecting the conveyor, the laser scanner, and the pair of IR temperature sensors for automatically self-adjusting heat transfer of the food product in the internal chamber.

### BRIEF DESCRIPTION OF THE DRAWING

For a more complete understanding of the present invention, reference may be had to the following description of exemplary embodiments considered in connection with the accompanying drawing Figure, of which:

The Figure shows a side plan view in cross-section of a self-adjusting cryogenic food freezer embodiment of the present invention.

### DETAILED DESCRIPTION OF THE INVENTION

Before explaining the inventive embodiments in detail, it is to be understood that the invention is not limited in its application to the details of construction and arrangement of parts illustrated in the accompanying drawing, since the invention is capable of other embodiments and being practiced or carried out in various ways. Also, it is to be understood that the phraseology or terminology employed herein is for the purpose of description and not of limitation.

In the following description, terms such a horizontal, upright, vertical, above, below, beneath and the like, are to used solely for the purpose of clarity illustrating the invention and should not be taken as words of limitation. The drawing is for the purpose of illustrating the invention and is not intended to be to scale.

Basically, the system embodiment of the Figure and described herein will actively monitor in real time both incoming and outgoing food product conditions and production rates. Conditions within the cryogenic food freezer are also monitored in real time. Use of an intelligent control philosophy for the present cryogenic food freezing system can automatically be adjusted and adapted to optimum efficiencies with a variety of process inputs to the system. The end result is a more efficient freezing solution along with additional data which can be fed to both upstream and downstream processes for a more effective control and uniformity of a food chilling or freezing process for the food product, and efficient use of the cryogenic substance for chilling and/or freezing of same.

A cryogenic food freezing system is one of many components arranged along a food processing line. The customers of such food freezing systems are concerned with the commercial value drivers, such as maximum product yield, improving process efficiency (such as reduced downtime of the system), and a reduction in the overall processing costs to use the system.

In view of the foregoing, there is provided a self-adjusting cryogenic food freezing apparatus 10 or apparatus for use in a food processing line in which products, such as any type of food product, are chilled or frozen for continuous or batch freezing applications. The apparatus 10 includes a housing 12 consisting of a plurality of sidewalls 14 for defining an internal space 16 or chamber therein. One of the sidewalls 14 is provided with an inlet 18, while another one of the sidewalls, usually positioned at an opposite end of the housing 12, includes an outlet 20. The inlet 18 and the outlet 20 provide for communication with respect to the chamber 16 and through which moves a transport assembly 22 or conveyor belt for conveying food product 24 from the inlet through the chamber to the outlet. The conveyor belt 22 can be of any know type of construction, such as for example a stainless steel mesh belt.

Cryogen is introduced through a pipe 26, the cryogen pipe, into the chamber 16. The pipe 26 includes a valve 28 such as a modulating control valve, to control or restrict the amount of cryogen being introduced into the chamber 16 of the apparatus 10. The cryogen pipe 26 is in fluid communication with a remote source (not shown) of cryogen which can be for example nitrogen, liquid nitrogen (LIN) or carbon dioxide snow. An end 30 of the pipe 26 in the chamber 16 is branched or split into a plurality of sections 32 or portions to provide a spray bar which operates as a distribution arm or manifold for the cryogen being provided from the pipe. The sections 32 may also be provided with at least one and for most applications a plurality of nozzles 34 which distribute or jet a spray 36 of the cryogen onto the food product 24 passing proximate thereto on the conveyor belt 22. The cryogen spray 36 is usually in the form of LIN or solid carbon dioxide (CO₂) snow for providing a thorough heat transfer effect of the underlying food product 24 passing beneath the nozzles 34,

The housing 12 is also provided with at least one and for most applications a plurality of motors 38, each one of which is connected to and drives a corresponding fan 40 for circulating the disbursed cryogenic spray and cold cryogenic gas 36 within the chamber 16, and to maintain atmosphere in the chamber to a substantially uniform temperature, although depending upon the cryogen process being used the atmosphere could be isothermal, co-current (temperature profiles in the same direction within the freezer atmosphere) or counter-current (temperature profiles in opposite or dissimilar directions within the freezer atmosphere). Movement of the fans 40 provides for distributing the cryogenic spray 36 across the chamber 16 so that food product 24 entering at the inlet 18 begins to be subjected to heat transfer and therefore chilling and/or freezing before reaching the portions 32 of the spray bar. The motor (38) is mounted external to the housing 12 so that heat from the motor(s) has minimal effect on the atmosphere in the chamber 16.

An array of sensors can be placed at the inlet 18, the outlet 20, and the chamber 16 to collect information about the chamber atmosphere and the status of the food products 24 as same are introduced into, subjected to, and depart from the chilling and/or freezing process of the apparatus 10. In particular, an infrared (IR) temperature sensor 42 can be mounted for actuation at the inlet 18, while another IR temperature sensor 44 is mounted at the outlet 20. At least one other temperature sensor 46 can be mounted for sensing a temperature of the chamber 16. The sensor 46 may be for example a resistance temperature detector (RTD), which is more accurate at lower temperatures than a thermocouple. An oxygen (O₂) sensor 48 is also provided to sense the oxygen content of the chamber 16. The O₂ sensor 48 is used to determine if air is being drawn into the freezing process from external to the housing 12.

A laser scanner 50 is mounted proximate the inlet 18 upstream of the IR temperature sensor 42, and which precisely records the continuous cross-section area of the food product entering the freezer at the inlet.

A controller 52 processes real time data from the sensors 42, 44, 46, 48 (collectively 42-48); the controller 52 interconnecting the sensors 42-48, the operation of the conveyor belt 22, the laser scanner 50, and the valve 28 in such a way so as to allow the freezer apparatus 10, without the necessity of an operator, to automatically control and optimize food freezing with the apparatus, Data collected from the sensors 42-48, including the laser scanner 50, can also provide feedback to the plant operator to permit more precise oversight and control of other processes positioned upstream and downstream of the present apparatus 10,

Still referring to the Figure, the laser scanner 50 provides data which can be used to calculate mass flow rates and loading of the food product 24 on the conveyor belt 22. The IR temperature sensor 42 at the inlet 18 will sense and monitor the food product temperature at the inlet with known thermal properties of the food product, ie the two data points described above: the cross-sectional area of the product 24 entering the freezer and the mass flow rates and loading of the product on the conveyor belt 22, such can be used to calculate real time production rate and therefore heat load of the food product entering the process provided by the apparatus 10. Accordingly, a speed of the conveyor belt 22 and the injection rates of the cryogen introduced by the pipe 26 into the chamber 16 can be adjusted in real time or “on the fly” to match food product heat load and maximum belt loading of the food product to provide a higher operating efficiency of heat transfer at the food product in the apparatus 10. The IR temperature sensor 44 located at the outlet 20 of the apparatus 10 is used to check heat removal from the product which has occurred from the process of the present embodiment. Accordingly, depending upon the heat removal that has occurred, delivery of the cryogen spray 36, speed of the fans 40, and speed of the conveyor belt 22 can be adjusted automatically to compensate for any inefficiencies or discrepancies in chilling and/or freezing the food product 24.

The freezer apparatus 10 and related process of the embodiments provide for an increase in processing efficiencies for the food product through the freezer apparatus and accordingly, a substantial reduction in manual labor necessary to “tune” the apparatus for the food product 24 being processed (chilled or frozen) in the apparatus.

It will be understood that the embodiments described herein are merely exemplary and that a person skilled in the art may make many variations and modifications without departing from the spirit and scope of the invention. All such variations and modifications are intended to be included within the scope of the invention as described and claimed herein. It should be understood that the embodiments described above are not only in the alternative, but can be combined.

What is claimed:

1. A method for freezing a food product in a cryogenic freezer, comprising:
sensing at least one physical characteristic of the food product in real time;
providing a cryogenic substance to the food product for heat transfer at said food product;
automatically self-adjusting the heat transfer at the food product responsive to the sensing the at least one physical characteristic; and
continuously self-adjusting the heat transfer for bringing the food product to a select temperature.

2. The method of claim 1, wherein the sensing comprises all physical characteristics of the food product, and a temperature of an atmosphere in the cryogenic freezer to which the food product is exposed.

3. The method of claim 1, wherein the sensing comprises further sensing of the food product at an inlet and an outlet of the cryogenic freezer.

4. The method of claim 1 wherein the sensing comprises further sensing an atmosphere and circulation assembly in the cryogenic freezer for the continuously self-adjusting of the heat transfer.

5. The method of claim 1, wherein the sensing comprises scanning the food product with a laser at an inlet of said cryogenic freezer, and further sensing a temperature of the food product with an infrared temperature sensor at an inlet and an outlet of the cryogenic freezer.

6. The method of claim 5, further comprising further self-adjusting the heat transfer depending upon the scanning and the further sensing.

7. The method of claim 1, further comprising monitoring oxygen content in the cryogenic freezer.

8. The method of claim 1, wherein the cryogenic substance is selected from the group consisting of nitrogen, liquid nitrogen, carbon dioxide snow, and a combination thereof.

9. The method of claim 1, further comprising further sensing at least one of conveying the food product through the cryogenic freezer, and the providing the cryogenic substance, for the continuously self-adjusting said heat transfer

10. A cryogenic freezer for a food product, comprising:
a housing having an internal chamber and a cryogen delivery member disposed therein.
a conveyor for conveying the food product through the internal chamber;
a laser scanner disposed at an inlet of the housing for scanning a cross-sectional area of the food product entering the cryogenic freezer;
a pair of infrared (IR) temperature sensors, wherein a first IR sensor is disposed downstream of the laser scanner and upstream of an inlet to said internal chamber, and a second IR sensor is disposed downstream of an outlet of said internal chamber; and
a controller interconnecting the conveyor, the laser scanner, and the pair of IR temperature sensors for automatically self-adjusting heat transfer of the food product in the internal chamber.

11. The freezer of claim 10, further comprising an oxygen sensor mounted for sensing oxygen content in the internal chamber.

12. The freezer of claim 10, further comprising a temperature sensor mounted for sensing a temperature of the internal chamber.

13. The freezer of claim 10, further comprising a control valve operatively associated with the cryogen delivery member, said control valve constructed and arranged to control an amount of cryogen introduced through the cryogen delivery member into the internal chamber.

14. The freezer of claim 10, further comprising a valve operatively associated with the cryogen delivery member.
